(19) United States
(12) Patent Application Publication
(10) Pub. No.: US 2002/0125993 A1
(43) Pub. Date: Sep. 12, 2002

(54) Apparatus and method for delivering an audio and/or video message to an individual

(75) Inventors: Srinivas Gutta, Buchanan, NY (US); Larry J. Eshelman, Ossining, NY (US); James A. Hoekema, Newburgh, NY (US); John G. Milanski, Boulder, CO (US); Hugo Strubbe, Yorktown Heights, NY (US)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/803,324

(22) Filed: Mar. 9, 2001

(51) Int. Cl. H04B 1/00; H04Q 1/00; H04B 3/00; G06F 7/00; G06F 7/04; H04Q 9/00; G08C 19/00; G05B 19/00; G05B 23/00; G08B 29/00

(52) U.S. Cl. 340/5.52; 340/7.52; 340/5.74

(57) ABSTRACT

A method for delivering an audio and/or video message to an individual. The method includes the steps of: receiving the message; detecting the presence of an individual; and if an individual is detected, delivering the message to the individual. Preferably, the message is recorded when received and associated with either a group of individuals, such as a family, or a particular individual whose facial image data is stored in a memory. If a facial recognition system detects someone from the group of individuals or the particular individual, the message is delivered to the individual by way of a video monitor and/or speaker. The method also preferably locates an individual who is associated with a message in a room in a structure and delivers the message to the room in which the individual is located.

### BACKGROUND OF THE INVENTION

1. Field of the Invention

The present invention relates generally to delivering a message to an individual and, more particularly, to apparatus and methods for delivering a video and/or audio message to an individual detected by a recognition system, such as a facial or speech recognition system.

2. Prior Art

Prior art message systems require a manual participation between a user of the system and the message machine. Typically, such systems, particularly for domestic use, comprises a recording machine having a canned message recorded by the user and a means for recording a message for the user, either digitally in memory or magnetically on tape. These messages are typically audio messages. In order to retrieve the message, the user must physically interact with the message system at the location where such system is fixed.

Furthermore, in typical message machines of the prior art, messages for an intended user can be retrieved by anyone having physical access to the message system, such as other members of a family or a guest, or even an intruder. Message machines of the prior can also be password protected where only those having the proper password can access the message system. However, if a password is forgotten, the messages cannot be retrieved. Furthermore, the use of a password is an additional inconvenience which is necessary for the secure delivery of messages in the systems of the prior art.

Lastly, message systems of the prior art typically record external messages which originate via the telephone and are thus only useful for messages between locations having different phone numbers, i.e., between different households or locations.

In view of the prior art, there is a need for a message system which overcomes the problems associated with the message systems of the prior art.

### SUMMARY OF THE INVENTION

Therefore it is an object of the present invention to provide an apparatus and method for delivering a message to an individual which is fully automated.

It is another object of the present invention to provide an apparatus and method for delivering a message to an individual which requires little or no physical interaction with a message machine.

It is yet another object of the present invention to provide an apparatus and method for delivering a message to an individual which can be used to send and retrieve messages between locations and also within the same location.

It is still yet another object of the present invention to provide an apparatus and method for delivering a message to an individual which can deliver secure messages to an intended individual without the inconvenience of a password as is used in the message systems of the prior art.

Accordingly, a method for delivering an audio and/or video message to an individual is provided. The method comprises the steps of: receiving and preferably recording the message; detecting the presence of an individual; and if an individual is detected, delivering the message to the individual.

In a first implementation of the methods of the present invention, the method further comprises the steps of: storing data characteristic of each of a group of individuals who are authorized to receive the message, such as members of a household; and comparing the detected individual with the data characteristic of each of the group of individuals, wherein the delivering step delivers the message if the detected individual is from the group of individuals.

In a second implementation of the methods of the present invention, the method further comprises the steps of: storing data characteristic of at least one individual; associating the message with the at least one individual; and comparing the detected individual with the data characteristic of the at least one individual, wherein the delivering step delivers the message if the detected individual is the at least one individual. Preferably, the at least one individual comprises a plurality of individuals, where the associating step associates the message with one of the plurality of individuals and the delivering step delivers the message if the individual associated with the message is detected.

In a first variation of the second implementation of the methods of the present invention, the detecting step comprises locating the at least one individual in a room of a structure and the delivering step comprises delivering the message to the at least one individual in the room in which the at least one individual is located.

In a second variation of the second implementation of the methods of the present invention, if the detected individual is not the at least one individual, the delivering step comprises delivering a canned message to the detected individual.

Preferably, in either the first or second implementations of the methods of the present invention, the data is either facial image data where the detecting step comprises recognizing the face of the individual or speech data where the detecting step comprises recognizing the speech pattern of the individual.

Also provided is an apparatus for delivering an audio and/or video message to an individual. The apparatus comprises: a means for receiving the message and preferably a recorder for recording the message; a detector for detecting the presence of an individual; and a player for delivering the message to the individual if the individual is detected.

In a first implementation of the apparatus of present invention, the apparatus further comprises: a data storage for storing data characteristic of each of a group of individuals who are authorized to receive the message, such as members of a household; and a comparing means for comparing the detected individual with the data characteristic of each of the group of individuals, wherein the player delivers the message if the detected individual is from the group of individuals.

In a second implementation of the apparatus of the present invention, the apparatus further comprises: a data storage for storing data characteristic of at least one individual; means for associating the message with the at least one individual; and comparing means for comparing the detected individual with the data characteristic of the at least one individual, wherein the player delivers the message if the detected individual is the at least one individual. Preferably, the at least one individual comprises a plurality of individuals, the means for associating the message associates the message with one of the plurality of individuals and the player delivers the message if the individual associated with the message is detected.

In a first variation of the second implementation of the apparatus of the present invention, the detector comprises means for locating the at least one individual in a room of a structure and the player delivers the message to the at least one individual in the room in which the at least one individual is located.

In a second variation of the second implementation of the apparatus of the present invention, the apparatus further comprises a memory for storage of at least one canned message, wherein if the detected individual is not the at least one individual the player delivers the at least one canned message to the detected individual.

The data is preferably either facial image data where the detector is a facial recognition system or speech data where the detector comprises a speech pattern recognition system. The message is preferably either a video message where the player is a video display for reproducing the video message or an audio message where the player is a speaker for reproducing the audio message.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 illustrates an apparatus for delivering a message to an individual.

FIG. 2 illustrates a variation of the apparatus of FIG. 1.

### DETAILED DESCRIPTION OF THE PREFERRED EMBODIMENT

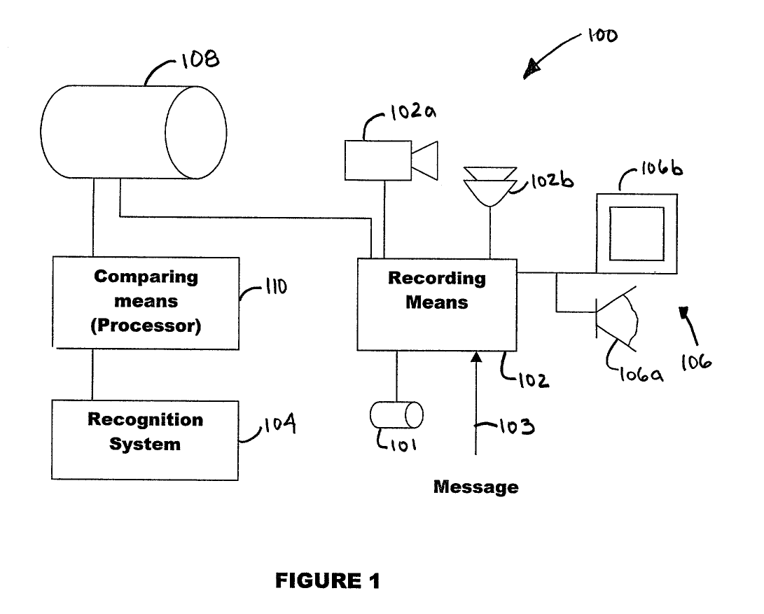

Referring now to FIG. 1, there is illustrated an apparatus for delivering a recorded audio and/or video message to an individual, the apparatus generally referred to by reference numeral 100. The apparatus comprises a recorder 102 for recording the message in an internal memory 101. The recorder 102 can record a video message and/or an audio message through a camera 102a or a microphone 102b, respectively, connected thereto. The recorder 102 can also receive a message over a data link 103 such as a telephone line or coaxial cable, from sources such as a telephone system, e-mail, or the internet. In such cases, the message is preferably recorded in the internal memory 101. Furthermore, the message can be digitally recorded on an appropriate medium for recording or storing digital data or the message can be recorded in an analog format such as on a magnetic tape. The recoding of messages, either video or audio, and in digital or analog formats are well known in the art. Although it is preferable to record and store a message that is to be delivered, the message can also be delivered live to the individual without first being stored.

The apparatus also includes a detector 104 for detecting the presence of an individual. The detector preferably includes a camera and/or microphone to detect the presence of a moving object and a recognition system to recognize the moving object as a person, collectively referred to below and in the Figures as a recognition system. Although the detector 104 can merely detect the presence of any person and deliver the message to that person, it is preferred that the detector 104 be capable of detecting a particular individual and delivering a message intended for that individual. To detect a particular individual, the detector 104 preferably includes means for detecting at least one characteristic of the individual, such as a facial recognition system and/or a speech recognition system such as that disclosed in Gutta et al., Face and Hand Gesture Recognition Using Hybrid Classifiers, Proceedings of the Second International Conference on Automatic Face and Hand Gesture Recognition, Oct. 14-16, 1996; and Colmenarez et al., Maximum Likelihood Face Detection, Proceedings of the Second International Conference on Automatic Face and Hand Gesture Recognition, Oct. 14-16, 1996.

Those skilled in the art will appreciate that facial and speech recognition systems are given by way of example only and not to limit the scope or spirit of the invention. Other recognition systems now known or later developed can also be used in the apparatus 100 of the present invention. The essential feature of the detector 104 is that it detect or recognize an individual from some characteristic of the individual which would make it more likely than not that the individual is the intended individual. However, as discussed above, the detector 104 can also detect for the presence of any person, in which case the recognition system can look for characteristics peculiar to humans, such as a face region or a particular motion that is characteristic of human movement.

The apparatus 100 also includes a player 106 for delivering the message to the individual if the individual is detected. Where the message is an audio message, the player 106 is a speaker 106a for reproducing the audio message. Where the message is a video message, the player 106 is a video display 106b for reproducing the video message and preferably also includes the speaker 106b for reproducing an audio portion of the video message.

In a first implementation of the apparatus 100 of the present invention, the apparatus 100 detects an individual and delivers the message if the individual is detected as belonging to a group of individuals who are authorized to receive the message, such as a family of a household. In the first implementation, the apparatus 100 further comprises a data storage 108 for storing data characteristic of each person in the group of individuals who are authorized to receive the message. Preferably, the camera 102a and/or microphone 102b of the recorder 102 can be used to record the data characteristic of the individuals from the group, such as the individual's facial image or speech pattern, and the data is stored in the data storage 108. However, separate means to record the data characteristic can be used without departing from the scope or spirit of the present invention.

A comparing means 110 would then be used to compare the detected individual to the data characteristic of each person in the group of individuals. If a match exists between the detected individual and one of the individuals from the group, the player 106 would be instructed, either directly or preferably through the recording means 102, to deliver the message to the detected individual by displaying the video message on the monitor 106b and/or playing the audio message on the speaker 106a of the player 106.

The comparing means 110 is preferably a processor which compares the data from the recognition system 104 and the data from the data storage 108 and outputs a degree of match between the two sets of data. If the data from the recognition system 104 and the data from the data storage 108 are not in the same format, a converter is necessary to convert one to the format of the other, such as a digital to analog converter (not shown). The processor 110 then makes a determination that there is a match where the degree of match is above a certain predetermined threshold. Such comparison means are well known in the art.

In a second implementation of the apparatus 100 of the present invention, the apparatus 100 detects an individual and delivers the message if the individual is detected as being a particular individual with which the message is associated. For instance, a message can be intended for a particular person in the household and not to anyone in the household in general. In the second implementation, the apparatus 100 includes the data storage 110 for storing data characteristic of the individual, such as the individual's facial image or speech pattern. As discussed above, the recorder 102 can be used to record such data or a separate means can be used. Preferably, data characteristics are stored for a plurality of individuals who may receive a message.

A means is provided in the message for associating the message with a particular individual for whom the message is intended. Such a means can be an identifying tag appended to the message, such as 01 for the father of the household, 02 for the mother, and so on. The data characteristics of each of the individuals stored in the data storage 108 would then have an identifying tag associated with each person's data characteristics or set of data characteristics. If a message includes such a tag, the detector 102 would look for an individual meeting the corresponding data characteristics and the message would be instructed to be delivered to an individual only if the comparing means 110 determines that the detected individual is the individual corresponding to the tag identifier.

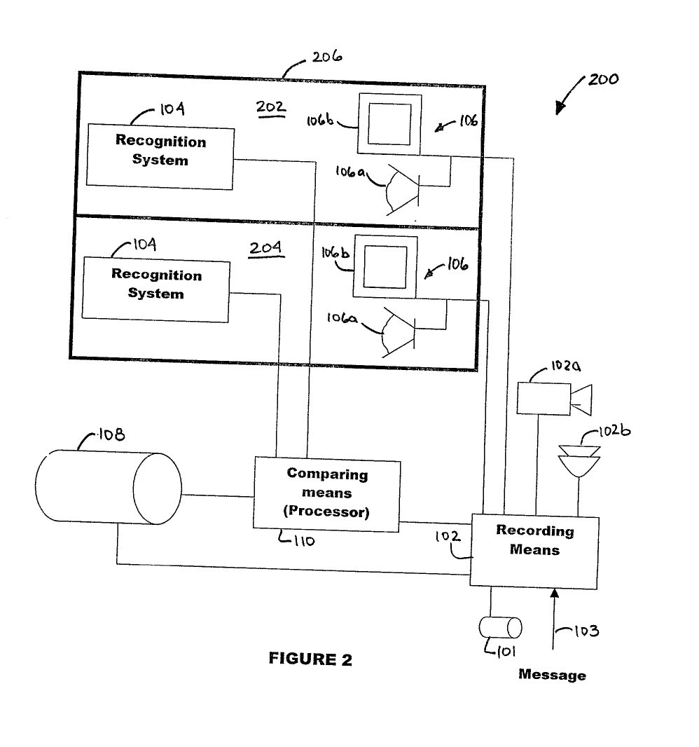

Referring now to FIG. 2, there is illustrated a variation of the second implementation of the apparatus of FIG. 1, generally referred to by reference numeral 200. The apparatus 200 of FIG. 2 is similar to the apparatus 100 of FIG. 1 with the exception that detectors 104 are placed in more than one room 202, 204 of a structure 206, such as a residential home. Furthermore, a player 106 is placed in at least those rooms which have the detector 104. Preferably, the detectors and players are placed in all the rooms of the structure 206. FIG. 2 illustrates the structure 206 having only two rooms 202, 204 for the sake of simplicity.

If a message is intended for a particular individual and contains an identifying tag as discussed above, the detectors 104 as illustrated in FIG. 2 can then locate the intended individual in a particular room 202, 204 of the structure 206 by scanning each room for the individual. If the intended individual is detected in one of the rooms 202, 204, the player 106 corresponding to the room in which the intended individual is detected is instructed to deliver the message to that individual. Thus, if an external message (i.e., a message originating from outside the structure) is received that is urgent or personal, the apparatus 200 can locate the individual for whom the message is intended and deliver the message to only that intended individual.

Additionally, if the message is also tagged as being confidential, it will not be delivered unless the intended individual is detected in a room and no other individuals are detected in the same room. In other words, a message that is tagged for a particular individual which is also tagged as being confidential will only be delivered when it is detected that the intended individual is alone in a room.

Furthermore, those skilled in the art will appreciate that the apparatus 200 of the present invention can locate an individual and deliver an internal message (i.e., a message originating from within the structure) to that individual, such as a parent locating a child to alert the child that dinner is ready.

Lastly, in either apparatus 100 or 200, if a message is intended for a member of a group or a particular person and someone other than a member of a group or a particular person is detected, a canned message can be delivered to the detected person from the memory 101. The canned message can be a greeting to a quest or a warning to an unauthorized intruder.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A method for delivering an audio and/or video message to an individual, the method comprising the steps of:
receiving the message;
detecting the presence of an individual; and
if an individual is detected, delivering the message to the individual.

2. The method of claim 1, further comprising the step of recording the received message.

3. The method of claim 2, further comprising the steps of:
storing data characteristic of each of a group of individuals who are authorized to receive the message; and
comparing the detected individual with the data characteristic of each of the group of individuals, wherein the delivering step delivers the message if the detected individual is from the group of individuals.

4. The method of claim 3, wherein the data is facial image data and the detecting step comprises recognizing the face of the individual.

5. The method of claim 3, wherein the data is speech data and the detecting step comprises recognizing the speech pattern of the individual.

6. The method of claim 3, wherein the group of individuals are members of a household.

7. The method of claim 2, further comprising the steps of:
storing data characteristic of at least one individual;
associating the message with the at least one individual; and
comparing the detected individual with the data characteristic of the at least one individual, wherein the delivering step delivers the message if the detected individual is the at least one individual.

8. The method of claim 7, wherein the data is facial image data and the detecting step comprises recognizing the face of the individual.

9. The method of claim 7, wherein the data is speech data and the detecting step comprises recognizing the speech pattern of the individual.

10. The method of claim 7, wherein the at least one individual comprises a plurality of individuals, the associating step associates the message with one of the plurality of individuals and the delivering step delivers the message if the individual associated with the message is detected.

11. The method of claim 7, wherein the detecting step comprises locating the at least one individual in a room of a structure and the delivering step comprises delivering the message to the at least one individual in the room in which the at least one individual is located.

12. The method of claim 7, wherein if the detected individual is not the at least one individual the delivering step comprises delivering a canned message to the detected individual.

13. An apparatus for delivering an audio and/or video message to an individual, the apparatus comprising:
means for receiving the message;
a detector for detecting the presence of an individual; and
a player for delivering the message to the individual if the individual is detected.

14. The apparatus of claim 13, further comprising a recorder for recording the received message.

15. The apparatus of claim 14, further comprising:
a data storage for storing data characteristic of each of a group of individuals who are authorized to receive the message; and
comparing means for comparing the detected individual with the data characteristic of each of the group of individuals, wherein the player delivers the message if the detected individual is from the group of individuals.

16. The apparatus of claim 15, wherein the data is facial image data and the detector comprises a facial recognition system.

17. The apparatus of claim 15, wherein the data is speech data and the detector comprises a speech pattern recognition system.

18. The apparatus of claim 15, wherein the group of individuals are members of a household.

19. The apparatus of claim 15, further comprising:
a data storage for storing data characteristic of at least one individual;
means for associating the message with the at least one individual; and
comparing means for comparing the detected individual with the data characteristic of the at least one individual, wherein the player delivers the message if the detected individual is the at least one individual.

20. The apparatus of claim 19, wherein the data is facial image data and the detector is a facial recognition system.

21. The apparatus of claim 19, wherein the data is speech data and the detector comprises a speech pattern recognition system.

22. The apparatus of claim 19, wherein the at least one individual comprises a plurality of individuals, the means for associating the message associates the message with one of the plurality of individuals and the player delivers the message if the individual associated with the message is detected.

23. The apparatus of claim 19, wherein the detector comprises means for locating the at least one individual in a room of a structure and the player delivers the message to the at least one individual in the room in which the at least one individual is located.

24. The apparatus of claim 19, further comprising a memory for storage of at least one canned message, wherein if the detected individual is not the at least one individual the player delivers the at least one canned message to the detected individual.

25. The apparatus of claim 13, wherein the message is a video message and the player is a video display for reproducing the video message.

26. The apparatus of claim 13, wherein the message is an audio message and the player is a speaker for reproducing the audio message.
